(19) United States
(12) Patent Application Publication
(10) Pub. No.: US 2026/0330497 A1
(43) Pub. Date: Oct. 22, 2026

(54) SYSTEMS AND METHODS FOR UTILIZING A REAL-TIME GENERATIVE ARTIFICIAL INTELLIGENCE MODEL TO GENERATE AN IMAGE BASED ON CAMPAIGN DATA

(71) Applicant: Verizon Patent and Licensing Inc., Basking Ridge, NJ (US)

(72) Inventors: NarayanaDhoss GOPALAKRISHNAN, Chennai (IN); Saravanan VIJAYAKUMAR, Tamil Nadu (IN); Arunkumar SURULINATHAN, Cumbum (IN); Ramprasath X. HARIHARAN, Chennai (IN)

(73) Assignee: Verizon Patent and Licensing Inc., Basking Ridge, NJ (US)

(21) Appl. No.: 19/185,714

(22) Filed: Apr. 22, 2025

(51) Int. Cl. G06Q 30/0242; G06Q 30/0241; G06Q 30/0251

(52) U.S. Cl. CPC G06Q 30/0244; G06Q 30/0264; G06Q 30/0276

(57) ABSTRACT

A device may receive, in real-time, viewership data from a plurality of user devices, and may provide the viewership data to a plurality of subscribers. The device may receive, from a subscriber of the plurality of subscribers, campaign data identifying details of an advertisement campaign, and may process the campaign data, with a generative artificial intelligence model, to generate an advertisement image for the advertisement campaign. The device may provide the advertisement image to the subscriber for approval, and may receive an approval of the advertisement image from the subscriber. The device may schedule provision of the advertisement image at a scheduled time based on receiving the approval of the advertisement image, and may provide the advertisement image to the plurality of user devices at the scheduled time and via one or more channels.

### BACKGROUND

Generative artificial intelligence (AI) models are a class of machine learning models designed to generate new data that is similar to a given set of training data. These models learn underlying patterns and structures of input data and produce new, synthetic data that mimics the input data.

### BRIEF DESCRIPTION OF THE DRAWINGS

FIGS. 1A-1E are diagrams of an example associated with utilizing a real-time generative AI model to generate an image based on campaign data.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing a real-time generative AI model to generate an image based on campaign data.

### DETAILED DESCRIPTION OF EXAMPLE EMBODIMENTS

The following detailed description of example implementations refers to the accompanying drawings. The same reference numbers in different drawings may identify the same or similar elements.

The creation and distribution of advertising content, such as images, banners, and posters, is a critical aspect of marketing strategies for businesses large and small. Traditional methods for developing and targeting advertisement campaigns are fraught with complexities and inefficiencies. Advertisers must typically engage with advertising agencies, select appropriate advertisement slots, and understand target audience demographics to create an effective advertisement campaign. Additionally, advertisers need to develop campaign content (e.g., images, posters, banners, and/or the like) which requires forethought about content, timing, and placement. This process can be time-consuming, expensive, and inaccessible for local or small-scale advertisers who may lack the resources or knowledge to effectively advertise.

The challenge is further compounded when trying to utilize real-time viewership data to make advertising decisions. The rapidly changing landscape of content consumption, with viewers spread across various platforms, such as traditional set-top boxes (STB), streaming services, and web platforms, requires a dynamic and responsive advertising strategy. Current systems do not support the agility needed for advertisers to react to viewership trends and preferences in real-time, limiting the ability of the advertisers to capitalize on immediate marketing opportunities. This lack of flexibility and speed can result in missed chances for targeted advertising and potentially lower return on investment for advertisement campaigns. Thus, current techniques for generating and providing advertising content consume computing resources (e.g., processing resources, memory resources, communication resources, and/or the like), networking resources, and/or other resources associated with utilizing traditional time-consuming advertising channels, failing to utilize real-time viewership data for advertising decisions, making incorrect advertising decisions based on failing to utilize real-time viewership data, correcting the incorrect advertising decisions, and/or the like.

Some implementations described herein provide an image system that utilizes a real-time generative AI model to generate an image based on campaign data. For example, the image system may receive, in real-time, viewership data from a plurality of user devices, and may provide the viewership data to a plurality of subscribers. The image system may receive, from a subscriber of the plurality of subscribers, campaign data identifying details of an advertisement campaign, and may process the campaign data, with a generative AI model, to generate an advertisement image for the advertisement campaign. The image system may provide the advertisement image to the subscriber for approval, and may receive an approval of the advertisement image from the subscriber. The image system may schedule provision of the advertisement image at a scheduled time based on receiving the approval of the advertisement image, and may provide the advertisement image to the plurality of user devices at the scheduled time and via one or more channels.

In this way, the image system utilizes a real-time generative AI model to generate an image based on campaign data. For example, the image system may utilize viewership data to trigger creation of advertisement content using a real-time generative AI model. The image system may enable subscribers (e.g., advertisers) to indicate advertising preferences such as channel selection, state selection, viewership thresholds, genre selection, and/or the like. The subscribers may also provide, to the image system, details of an advertisement campaign, such as a landing page network address, a coupon code, timing, template choices, and/or the like. Once a subscriber approves the advertisement content (e.g., an advertisement image), the image system may schedule the advertisement image for display at a predetermined time via various channels, such as television guide launch pages, mobile notifications, web pages, and/or the like.

Thus, the image system may conserve computing resources, networking resources, and/or other resources that would have otherwise been consumed by utilizing traditional time-consuming advertising channels, failing to utilize real-time viewership data for advertising decisions, making incorrect advertising decisions based on failing to utilize real-time viewership data, correcting the incorrect advertising decisions, and/or the like. Furthermore, the use of a generative AI model may facilitate rapid production of tailored advertisement images, which may conserve processing resources by reducing the need for manual content creation. The automated scheduling and distribution of advertisement content optimized for viewership patterns may conserve network resources by streamlining the delivery process and reducing transmission of less relevant advertisements. The image system may integrate with campaign management systems, which may potentially increase an efficiency of advertisement placement and may reduce computational overhead associated with advertisement campaign setup and execution.

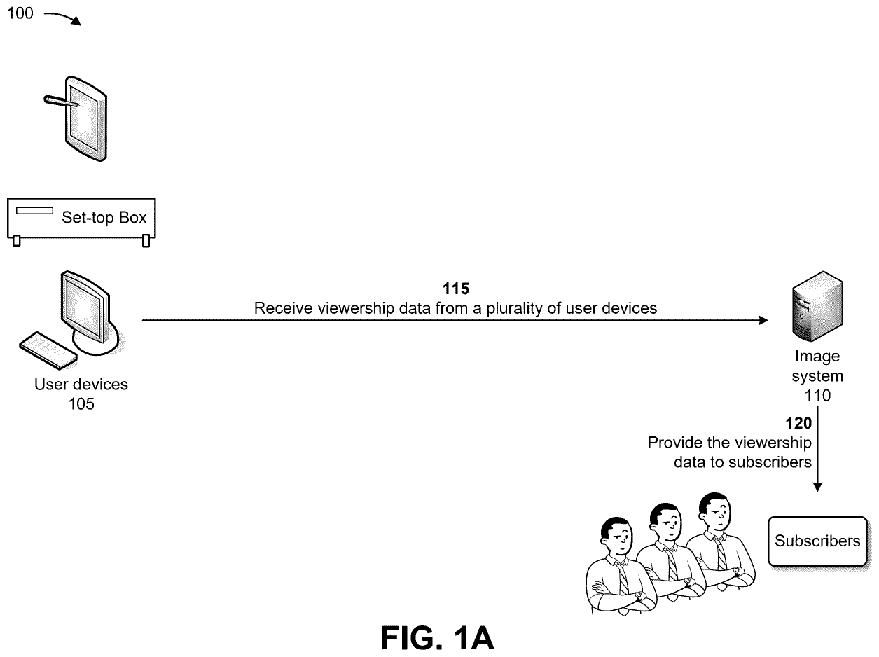

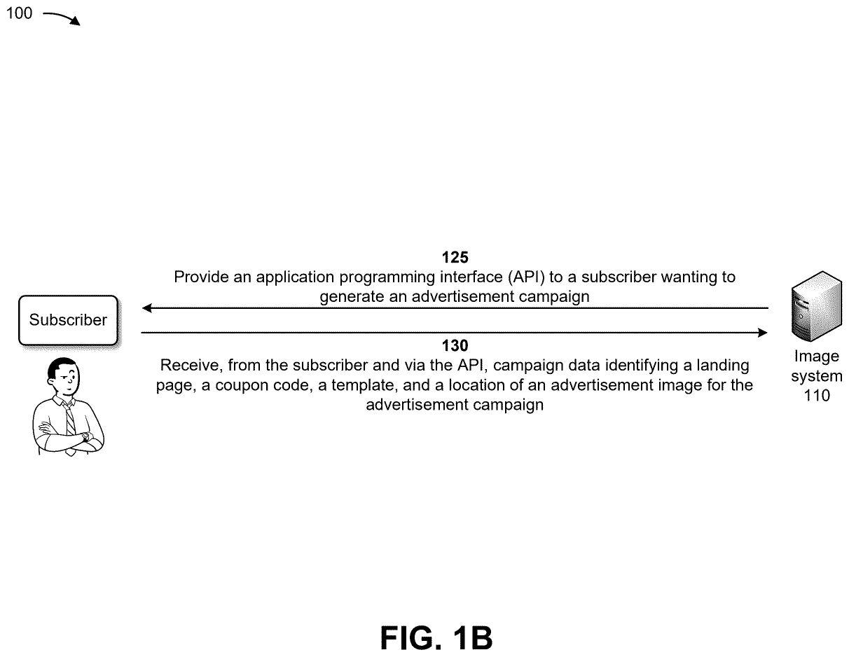

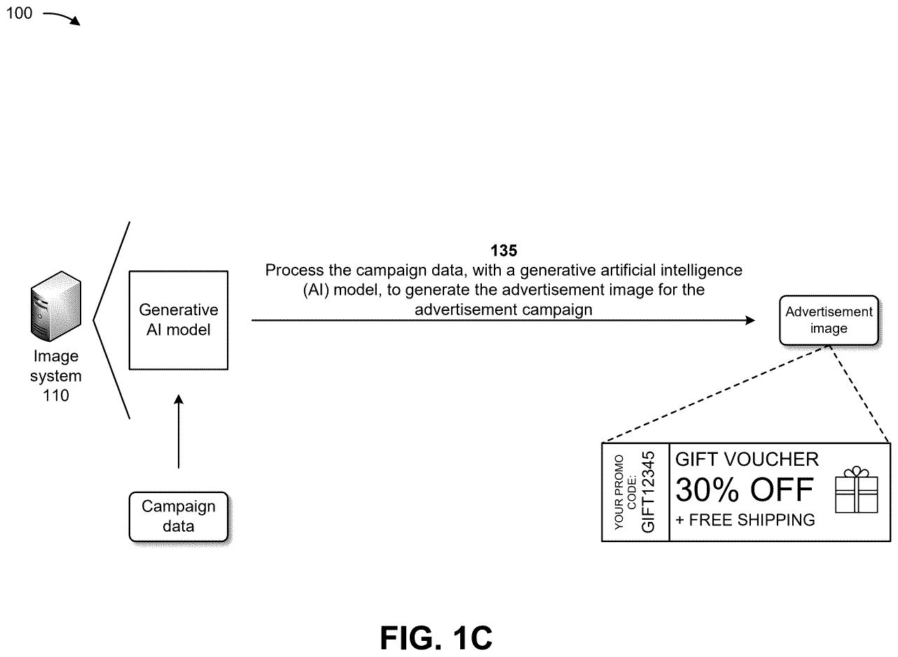

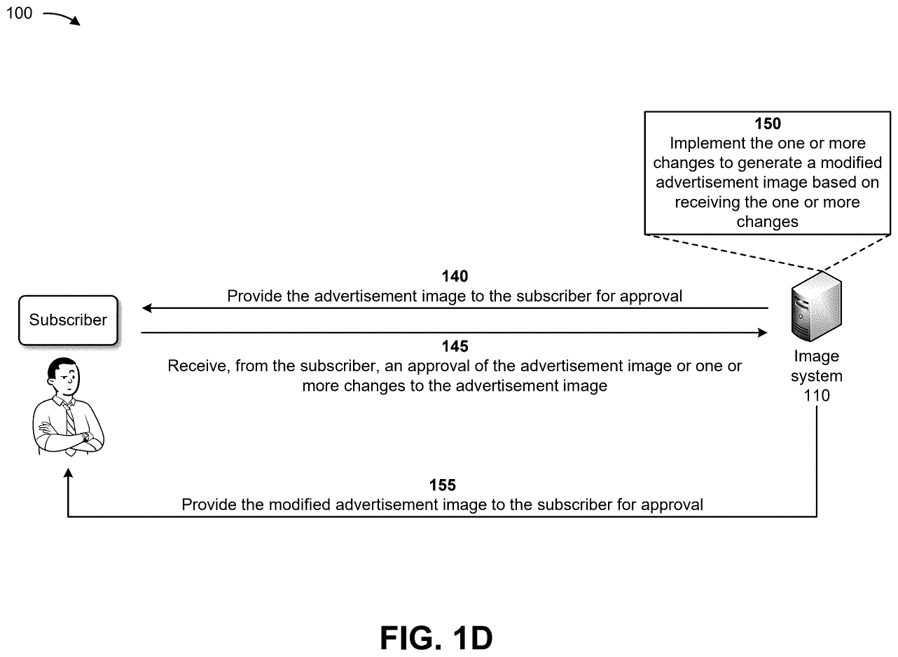

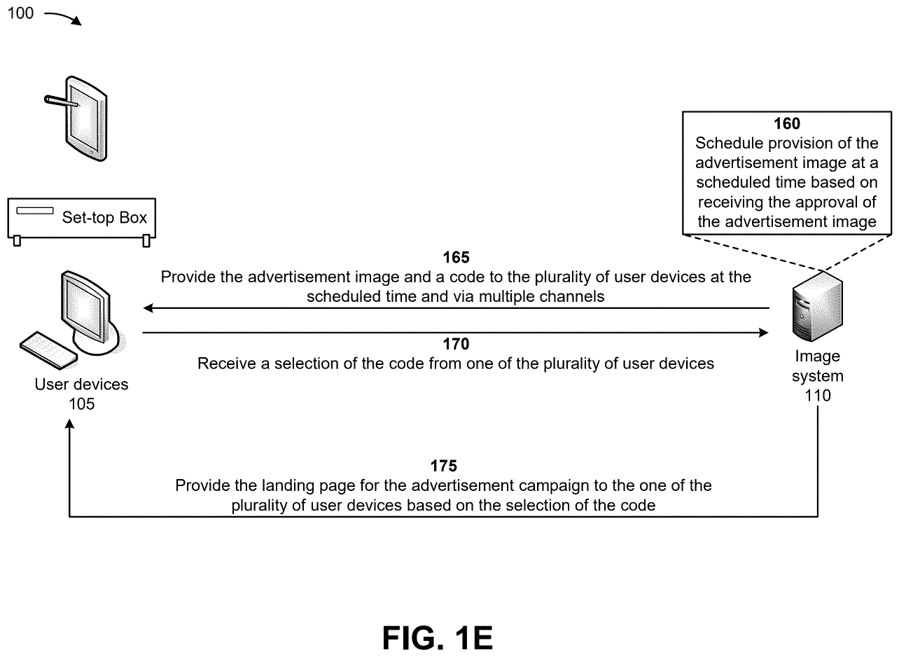

FIGS. 1A-1E are diagrams of an example 100 associated with utilizing a real-time generative AI model to generate an image based on campaign data. As shown in FIGS. 1A-1E, the example 100 includes a plurality of user devices 105 associated with an image system 110. Each of the user devices 105 includes a set-top box, a desktop computer, a tablet computer, a smartphone, a television, and/or the like. The image system 110 may include a system that utilizes a real-time generative AI model to generate an image based on campaign data. Further details of the user devices 105 and the image system 110 are provided elsewhere herein.

As shown in FIG. 1A, and by reference number 115, the image system 110 may receive viewership data from the plurality of user devices 105. For example, the plurality of user devices 105 may be utilized by viewers to view content provided by a content provider (e.g., a television service provider, a streaming content service provider, and/or the like). The plurality of user device devices 105 may generate the viewership data based on the viewers utilizing the plurality of user devices 105 to view the content provided by the content provider. The plurality of user devices 105 may provide the viewership data to the image system 110. The image system 110 may continuously receive the viewership data from the plurality of user devices 105 in real-time, may periodically receive the viewership data from the plurality of user devices 105, may receive the viewership data from the plurality of user devices 105 based on requesting the viewership data, and/or the like. The viewership data may include data related to content being viewed, durations of the viewings, times of the viewings, viewer interactions, viewer demographics, and other relevant data points.

In some implementations, the viewership data may be generated via other mechanisms, from which the image system 110 may receive the viewership data. For example, the viewership data may be generated through collection and analysis of information regarding audience interaction with media content. Various methods may be utilized to gather the viewership data, including conducting surveys and panels (e.g., where selected groups of viewers are asked to report their viewing habits), utilizing the plurality of user devices 105 to track what content is being watched and for how long, utilizing online streaming platforms to collect data on user interactions, such as clicks, views, and watch time, and/or the like. The viewership data from different sources may be aggregated and processed to provide a comprehensive view of viewership patterns. Advanced analytics and models may be applied to the processed viewership data to identify trends, patterns, and insights. This may include demographic analysis, peak viewing times, and content popularity. The analyzed viewership data may be compiled into reports and dashboards for subscribers, such as advertisers, broadcasters, and content creators, to make informed decisions.

As further shown by FIG. 1A, and by reference number 120, the image system 110 may provide the viewership data to subscribers. For example, the image system 110 may be associated with subscribers, such as advertisers. The advertisers may subscribe to the viewership data based on predefined criteria, such as viewership data associated with select channels, select states, select thresholds of viewership, select genres, and/or the like. The image system 110 sets up subscriptions with advertisers for viewership data through a structured and interactive process, ensuring that advertisers can effectively utilize the data for their advertising campaigns. For example, an advertiser interested in subscribing to viewership data may initiate contact with the image system 110 through a web portal, an application, or direct communication with a sales representative, and may create an account on the image system 110. The image system 110 may verify the advertiser's details to ensure legitimacy. The image system 110 offers various subscription plans tailored to different needs. These plans may vary based on the volume of data, the frequency of updates, and the level of detail provided. The advertiser can customize a subscription plan by selecting specific criteria such as geographic regions (e.g., state selection), channels, genres, and viewership thresholds. This customization ensures that the advertiser receives the most relevant data for their campaigns. The image system 110 may offer subscription plans to the advertiser, and the advertiser may select a subscription plan from the offered subscription plans.

Once the subscription plan is selected, the image system 110 may provide the advertiser with access to an application programming interface (API). This API may enable the advertiser to interact with the image system 110 and retrieve viewership data. The advertiser may utilize the API or a web-based dashboard to set up preferences, such as channel selection (e.g., specific television channels or streaming platforms), state selection (e.g., geographic regions where data is relevant), viewership thresholds (e.g., a minimum number of viewers required for the data to be considered significant), genre selection (e.g., types of that are of interest), real-time updates (e.g., how frequently updates are received), and/or the like.

The image system 110 may continuously collect and processes viewership data from a plurality of user devices 105, may filter the data based on the advertiser's criteria, and may deliver the viewership data to the advertiser in real-time through the API. In some implementations, the advertiser may set up alerts to be notified when certain conditions are satisfied (e.g., a viewership threshold is satisfied). Notifications can be sent via email, text message, or through a dashboard. The advertiser may analyze the viewership data to make informed decisions about an advertising campaign (e.g., peak viewing times, popular content genres, and demographic insights). Using the insights gained from the data, the advertiser may create highly targeted advertising campaigns. The advertiser may periodically review the performance of the campaigns using the viewership data, and may provide feedback to the image system 110 on the quality and relevance of the viewership data. The image system 110 may continuously improve data collection and processing models based on the advertiser feedback and technological advancements, ensuring that advertisers receive the most accurate and actionable data.

The image system 110 may analyze the viewership data and may distribute the analyzed viewership data to different subscribers based on the predefined criteria associated with the different subscribers. The subscribers may utilize the viewership data to make informed decisions about their advertisement campaigns and target specific audiences more effectively. In some implementations, the image system 110 may provide the viewership data to user devices 105 associated with the subscribers, to server devices associated with the subscribers, to cloud-based systems associated with the subscribers, via a portal provided by the image system 110 to the subscribers, and/or the like. The image system 110 may continuously provide the viewership data to the subscribers in real-time, may periodically provide the viewership data to the subscribers, may provide the viewership data to the subscribers based on receiving a request for the viewership data from the subscribers, and/or the like.

As shown by FIG. 1B, and by reference number 125, the image system 110 may provide an application programming interface (API) to a subscriber wanting to generate an advertisement campaign. For example, a subscriber of the plurality of subscribers may wish to generate an advertisement campaign based on the viewership data (e.g., when a quantity of viewers accessing content satisfies a viewership threshold). The image system 110 may facilitate the creation and management of the advertisement campaign by enabling the subscriber (e.g., an advertiser) to interact with the image system 110 through the API. In some implementations, the subscriber may request access to the API, and the image system 110 may grant API access to the subscriber based on the request. The API may enable the subscriber to input necessary advertisement campaign details without requiring extensive technical knowledge or manual intervention. In some implementations, the API may provide a plurality of templates for generating an advertisement image for the advertisement campaign, information requesting identification of a network address of a landing page (e.g., a standalone web page where visitors “land” after selecting a link) for the advertisement campaign, information requesting identification of a coupon code for the advertisement image, information requesting identification of a location of the advertisement image within displayed content (e.g., a banner provided at a top portion or a bottom portion of displayed content), and/or the like.

As further shown by FIG. 1B, and by reference number 130, the image system 110 may receive, from the subscriber and via the API, campaign data identifying details of the advertisement campaign, such as a landing page, a coupon code, a template, and a location of an advertisement image for the advertisement campaign. For example, the subscriber may utilize the API to provide the campaign data to the image system 110. The campaign data may include data identifying a network address (e.g., uniform resource locator (URL)) of the landing page where viewers will be directed, a unique coupon code for promotional purposes, a template (e.g., selected from a plurality of templates) to be used for the advertisement image, the intended location for displaying the advertisement, a start date and/or time for displaying the advertisement image, an end date and/or time for displaying the advertisement image, an address of the subscriber, business locations of the subscriber, products and/or services offered by the subscriber, and/or the like. The image system 110 may utilize the campaign data to generate a relevant and effective advertisement image tailored to the subscriber's requirements.

In some implementations, the image system 110 may offer an advertiser with one or more images to choose from. The one or more images may be generated from predefined templates that the image system 110 may utilize to create advertisement images quickly and easily. These templates may include various layouts, color schemes, and design elements tailored to different types of advertisement campaigns. For example, templates may be available for seasonal promotions, product launches, service announcements, and more. The image system 110 can customize these templates by adding text, images, logos, and other elements. The customization options may include selecting font styles, adjusting color palettes, and positioning visual elements. This flexibility enables the image system 110 to create visually appealing and effective advertisement images.

As shown by FIG. 1C, and reference number 135, the image system 110 may process the campaign data, with a generative AI model, to generate an advertisement image for the advertisement campaign. For example, the image system 110 may be associated with a generative AI model, such as an image generative AI model. An image generative AI model may include a model designed to create new images or to modify existing images. The image generative AI model may include a model that is based on deep learning techniques, such as a generative adversarial network (GAN) model or a variational autoencoder (VAE) model. A GAN model may include two neural networks, a generator and a discriminator, that are trained simultaneously. The generator may create images, while the discriminator may evaluate the created images against real images, providing feedback to improve the generator's output. A VAE model may include an encoder that compresses an input image into a latent space and a decoder that reconstructs the input image from the latent representation. The image system 110 may train the image generative AI model with a large dataset of images to learn underlying patterns and features. The image generative AI model may include a lower-dimensional space where the image generative AI model may represent features of images. By sampling from this space, the image generative AI model can generate new images with similar characteristics to training data. The GAN model may utilize an adversarial loss function, where the generator tries to minimize the difference between generated and real images, while the discriminator tries to maximize the difference. The VAE model may utilize a combination of a reconstruction loss function (e.g., a difference between original and reconstructed images) and a Kullback-Leibler divergence (e.g., a difference between the learned latent space distribution and a prior distribution).

In some implementations, the image system 110 may utilize the generative AI model to create a tailored advertisement image based on the campaign data, which may ensure that the advertisement image is relevant and effective for the advertisement campaign. This may provide for rapid and personalized advertisement image generation, reducing the need for manual content creation and enabling advertisers to quickly respond to real-time viewership data. The advertisement image may align with the campaign data (e.g., the network address of the landing page, the coupon code, the selected template, the intended location, timing details, the subscriber information, and/or the like), ensuring that the advertisement image is targeted and impactful for the advertising campaign of the subscriber.

To train the generative AI model, the image system 110 may retrieve a large dataset of advertisement images and associated metadata. This dataset may include diverse examples that cover various templates, target demographics, and advertising channels. The training process may include a data preprocessing stage where images are normalized, augmented, and annotated with relevant features such as color schemes, text overlays, and image dimensions. The GAN model may then be initialized with random weights, and the training process may utilize a stochastic gradient descent (SGD) optimizer to minimize an adversarial loss function. The generator network of the GAN model may produce images from random noise vectors, while the discriminator network may evaluate the authenticity of the generated images against real images from the training dataset. During each iteration of training, the generator may attempt to produce more realistic images, while the discriminator becomes better at distinguishing real from fake images. This adversarial process may continue until the generator produces high-quality images that are nearly indistinguishable from real images. The image system 110 may employ a validation set to periodically assess the performance of the GAN model and prevent overfitting. Hyperparameters such as a learning rate, a batch size, and a number of training epochs may be tuned to optimize the GAN model's performance.

Once adequately trained, the GAN model may be deployed within the image system 110 where it receives campaign data inputs, including details like landing page URLs, coupon codes, and desired templates. The GAN model may process these inputs by encoding them into a fixed-length vector that serves as the input for the generator. The generator may produce a customized advertisement image that aligns with the campaign data. The image system 110 may include mechanisms for real-time data integration, allowing the image system 110 to adjust the generated content based on live viewership data and predefined criteria set by subscribers. The image system 110 may maintain detailed logs and analytics to continuously monitor performance and make iterative improvements.

As shown by FIG. 1D, and reference number 140, the image system 110 may provide the advertisement image to the subscriber for approval. For example, the image system 110 may provide the advertisement image to the subscriber via the API provided to the subscriber, via a portal provided to the subscriber, via a user device 105 associated with the subscriber, via a server device associated with the subscriber, via a cloud-based device associated with the subscriber, and/or the like. In some implementations, the image system 110 may provide the advertisement image to the subscriber for approval by sending a link to the advertisement image to a device associated with the subscriber. For example, the image system 110 may generate a unique link or network address for the advertisement image and may share the link or the network address with the subscriber through a secure communication channel. Additionally, or alternatively, the image system 110 may generate a preview of the advertisement image for the subscriber to review. For example, the image system 110 may create a low-resolution version or a thumbnail of the advertisement image for quick assessment by the subscriber.

Additionally, or alternatively, the image system 110 may display the advertisement image on a dashboard accessible by the subscriber. The dashboard may provide various tools for the subscriber to interact with the advertisement image, such as zooming in and out of the advertisement image, adding comments to the advertisement image, and/or editing the advertisement image. Additionally, or alternatively, the image system 110 may email the network address of the advertisement image to the subscriber for review. This may ensure that the subscriber can conveniently access the advertisement image directly from an email account. Additionally, or alternatively, the image system 110 may notify the subscriber when the advertisement image is ready for review. This notification may be sent via email, text message, or through the dashboard, alerting the subscriber that the advertisement image is available for assessment.

As further shown by FIG. 1D, and reference number 145, the image system 110 may receive, from the subscriber, an approval of the advertisement image or one or more changes to the advertisement image. For example, the subscriber may review the advertisement image and either approve the advertisement image as is or request modifications (e.g., one or more changes) to the advertisement image by submitting feedback to the image system 110. In some implementations, the image system 110 may receive the approval of the advertisement image from the subscriber. Alternatively, the image system 110 may receive feedback from the subscriber regarding the advertisement image. The feedback may include comments about the advertisement image, suggestions about the advertisement image, specific changes that need to be made to the advertisement image, and/or the like.

As further shown by FIG. 1D, and reference number 150, the image system 110 may implement the one or more changes to generate a modified advertisement image based on receiving the one or more changes. For example, when the image system 110 receives the one or more changes to the advertisement image, the image system 110 may process the one or more changes, with the generative AI model, to generate the modified advertisement image (e.g., a revised version of the advertisement image. The modified advertisement image may include the advertisement image as modified based on the one or more changes. The generative AI model may intelligently apply the one or more changes to the advertisement image in order to maintain an overall quality and intent of the advertisement image.

As further shown by FIG. 1D, and reference number 155, the image system 110 may provide the modified advertisement image to the subscriber for approval. For example, the image system 110 may provide the modified advertisement image to the subscriber via the API provided to the subscriber, via a portal provided to the subscriber, via a user device 105 associated with the subscriber, via a server device associated with the subscriber, via a cloud-based device associated with the subscriber, and/or the like. In some implementations, the image system 110 may provide the modified advertisement image to the subscriber for approval by sending a link to the modified advertisement image to a device associated with the subscriber. For example, the image system 110 may generate a unique link or network address for the modified advertisement image and may share the link or the network address with the subscriber through a secure communication channel. Additionally, or alternatively, the image system 110 may generate a preview of the modified advertisement image for the subscriber to review. For example, the image system 110 may create a low-resolution version or a thumbnail of the modified advertisement image for quick assessment by the subscriber. The subscriber may evaluate the one or more changes in the modified advertisement image and approve the modified advertisement image.

Additionally, or alternatively, the image system 110 may display the modified advertisement image on the dashboard accessible by the subscriber. The dashboard may provide various tools for the subscriber to interact with the modified advertisement image, such as zooming in and out of the modified advertisement image, adding comments to the modified advertisement image, and/or editing the modified advertisement image. Additionally, or alternatively, the image system 110 may email the network address of the modified advertisement image to the subscriber for review. This may ensure that the subscriber can conveniently access the modified advertisement image directly from an email account. Additionally, or alternatively, the image system 110 may notify the subscriber when the modified advertisement image is ready for review. This notification may be sent via email, text message, or through the dashboard, alerting the subscriber that the modified advertisement image is available for assessment.

As shown in FIG. 1E, and by reference number 160, the image system 110 may schedule provision of the advertisement image at a scheduled time based on receiving the approval of the advertisement image. For example, once the advertisement image is approved by the subscriber, the image system 110 may determine a suitable time for displaying the advertisement image based on various factors, such as the subscriber's preferences, viewership patterns, availability of advertisement slots, and/or the like. In some implementations, scheduling the provision of the advertisement image may include creating a detailed schedule for the delivery of the advertisement image to various user devices 105. For example, the image system 110 may determine optimal times for displaying the advertisement image to each user device 105 based on historical data. Additionally, or alternatively, scheduling the provision of the advertisement image may include dynamically adjusting a delivery schedule of the advertisement image based on real-time viewership data and changes in subscriber preferences. This may ensure that the advertisement image is displayed at optimal times to maximize visibility and impact.

In some implementations, the subscriber may prebook one or more time slots for displaying the advertisement image by paying a premium for one or more time slots. This prebooking may be based on the viewership data (e.g., a quantity of viewers) satisfying a viewership threshold at a particular time and on a particular channel. Once the prebooking criteria are satisfied, the image system 110 may display the advertisement image during the one or more time slots. The prebooking feature may enable subscribers to secure premium advertisement slots in advance, ensuring that their advertisements are shown to a large audience at optimal times. Subscribers may pay a premium for the ability to prebook these slots, which guarantees that their advertisement will be prioritized over others. The image system 110 may monitor real-time viewership data and automatically schedule the advertisement image for display once the specified threshold is met.

In some implementations, the image system 110 may automatically create the advertisement campaign in a campaign management system based on the advertisement image and the details of the advertisement campaign. A campaign management system may help advertisers plan, execute, manage, and analyze advertisement campaigns. The campaign management system may be utilized to streamline the process of creating and managing advertisement initiatives across various channels, such as email, social media, direct mail, and/or the like. The image system 110 can automatically generate and configure advertisement campaigns within the campaign management system. This automated process may include setting up campaign parameters such as start and end dates, target demographics, preferred channels, and budget allocations. The image system 110 may dynamically adjust campaign settings in response to real-time viewership data and subscriber preferences. By automating these tasks, the image system 110 may reduce the administrative burden on subscribers, enabling them to focus on strategic decision-making and creative aspects of their campaigns.

As further shown in FIG. 1E, and by reference number 165, the image system 110 may provide the advertisement image and a code to the plurality of user devices 105 at the scheduled time and via multiple channels. For example, the image system 110 may distribute the advertisement image and the code to the plurality of user devices 105 at the scheduled time (e.g., one or more time slots). The image system 110 may distribute the advertisement image and the code through various channels, such as television guide launch pages, mobile notifications, web pages, and other digital platforms. In some implementations, the image system 110 may distribute the advertisement image and the code through additional channels such as email newsletters, social media platforms, and in-application notifications. These alternative channels may broaden the reach of the advertisement campaign and enhance user engagement. Additionally, or alternatively, the image system 110 may integrate with third-party advertising platforms and networks to expand the scope of advertisement distribution. This integration may provide for a wider audience reach and more diverse advertisement placements. The code provided with the advertisement image may include a quick response (QR) code, a coupon code, or another type of code that allows users (e.g., of the plurality of user devices 105) to easily access additional information or promotional offers related to the advertisement image.

In addition to traditional channels, the image system 110 may integrate with various omni-channel platforms to distribute advertisement images. These platforms may include email newsletters, social media networks, mobile applications, and web-based notifications. By leveraging omni-channel distribution, the image system 110 may ensure that advertisement images reach a broader audience and engage users across multiple touchpoints. This integration may enable subscribers to create cohesive and synchronized advertisement campaigns that maintain consistent messaging and branding across different platforms. The image system 110 may provide tools for tracking engagement metrics and performance analytics for each channel, enabling subscribers to optimize their campaigns based on real-time feedback.

In some implementations, the image system 110 may provide real-time notifications and alerts to subscribers. These notifications may inform subscribers about important events such as the completion of advertisement image generation, approval status updates, and changes in viewership data that may impact their campaigns. Notifications can be delivered through various channels, including email, text messages, and in-application messages within a subscriber dashboard. Real-time alerts may ensure that subscribers are promptly informed about critical developments and can take immediate action to optimize their advertisement campaigns. For example, a subscriber may receive an alert when a prebooked advertisement slot is triggered based on viewership thresholds, allowing them to monitor the campaign's performance.

As further shown in FIG. 1E, and by reference number 170, the image system 110 may receive a selection of the code from one of the plurality of user devices 105. For example, a user of one of the user devices 105 may utilize the user device to select the code, scan the code, or enter the code provided with the advertisement image. The image system 110 may detect and process the selection of the code to initiate further actions. For example, the selection of the code may cause the image system 110 to automatically direct the user to a landing page, to initiate a purchase flow, to provide additional information about a product or a service, and/or the like.

As further shown in FIG. 1E, and by reference number 175, the image system 110 may provide the landing page for the advertisement campaign to the one of the plurality of user devices 105 based on the selection of the code. For example, upon detecting that a user of one of the plurality of user devices 105 has selected the code, the image system 110 may direct the corresponding user device 105 to a designated landing page that contains more details about the advertisement campaign, such as promotional offers, product information, service information, information about the subscriber, ways to redeem the coupon code, and/or the like. In some implementations, the user may redeem the coupon code directly on the landing page, which may streamline the user experience and encourage immediate engagement with the promotional offer.

In some implementations, the image system 110 may be modular, allowing for easy integration with existing content delivery networks, advertisement management platforms, and real-time analytics tools. Security protocols, including data encryption and access control mechanisms, may be implemented by the image system 110 to ensure confidentiality and integrity of sensitive campaign data. The API provided to subscribers may provide for uploading campaign data, retrieving generated images, and managing advertisement schedules. The image system 110 may include user-friendly interfaces for subscribers to input the campaign data, preview generated images, and provide feedback. The image system 110 may support various image formats and resolutions to cater to different advertising channels, ensuring broad compatibility and optimal display quality. The architecture of the image system 110 may be fault-tolerant, with redundant components and failover mechanisms to maintain continuous operation even during hardware or network failures.

In this way, the image system 110 utilizes a real-time generative AI model to generate an image based on campaign data. For example, the image system 110 may utilize viewership data to trigger creation of advertisement content using a real-time generative AI model. The image system 110 may enable subscribers (e.g., advertisers) to indicate advertising preferences such as channel selection, state selection, viewership thresholds, genre selection, and/or the like. The subscribers may also provide, to the image system 110, details of an advertisement campaign, such as a landing page network address, a coupon code, timing, template choices, and/or the like. Once a subscriber approves the advertisement content (e.g., an advertisement image), the image system 110 may schedule the advertisement image for display at a predetermined time via various channels, such as television guide launch pages, mobile notifications, web pages, and/or the like.

Thus, the image system 110 may conserve computing resources, networking resources, and/or other resources that would have otherwise been consumed by utilizing traditional time-consuming advertising channels, failing to utilize real-time viewership data for advertising decisions, making incorrect advertising decisions based on failing to utilize real-time viewership data, correcting the incorrect advertising decisions, and/or the like. Furthermore, the use of a generative AI model may facilitate rapid production of tailored advertisement images, which may conserve processing resources by reducing the need for manual content creation. The automated scheduling and distribution of advertisement content optimized for viewership patterns may conserve network resources by streamlining the delivery process and reducing transmission of less relevant advertisements. The image system 110 may integrate with campaign management systems, which may potentially increase an efficiency of advertisement placement and may reduce computational overhead associated with advertisement campaign setup and execution.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

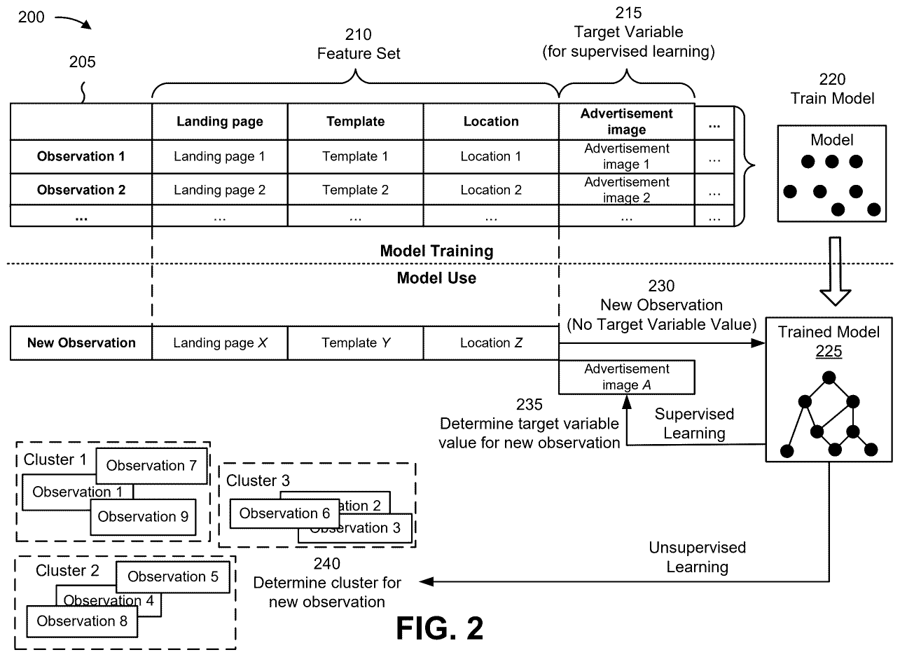

FIG. 2 is a diagram illustrating an example 200 of training and using a machine learning model. The machine learning model training and usage described herein may be performed using a machine learning system. The machine learning system may include or may be included in a computing device, a server, a cloud computing environment, and/or the like, such as the image system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the image system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the image system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of a landing page, a second feature of a template, a third feature of a location, and so on. As shown, for a first observation, the first feature may have a value of landing page 1, the second feature may have a value of template 1, the third feature may have a value of location 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “advertisement image” and may include a value of advertisement image 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of landing page X, a second feature of template Y, a third feature of location Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of advertisement image A for the target variable of the advertisement image for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a landing page cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a template cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generate advertisement images based on campaign data. The machine learning system enables recognition and/or identification of tens, hundreds, thousands, or millions of features and/or feature values for tens, hundreds, thousands, or millions of observations, thereby increasing accuracy and consistency and reducing delay associated with generating advertisement images based on campaign data relative to requiring computing resources to be allocated for tens, hundreds, or thousands of operators to manually generate advertisement images based on campaign data.

As indicated above, FIG. 2 is provided as an example. Other examples may differ from what is described in connection with FIG. 2.

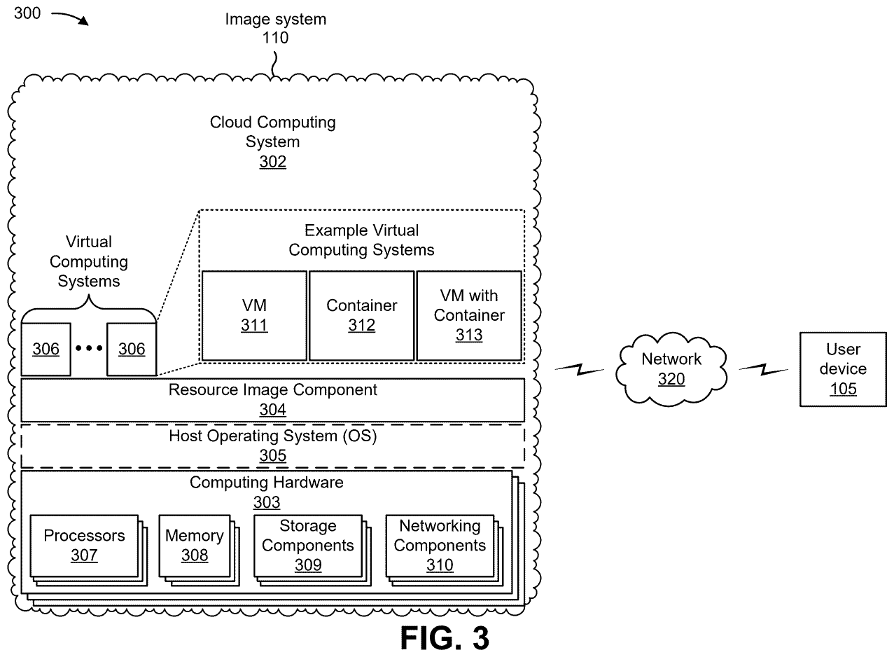

FIG. 3 is a diagram of an example environment 300 in which systems and/or methods described herein may be implemented. As shown in FIG. 3, the environment 300 may include the image system 110, which may include one or more elements of and/or may execute within a cloud computing system 302. The cloud computing system 302 may include one or more elements 303-313, as described in more detail below. As further shown in FIG. 3, the environment 300 may include a user device 105 and/or a network 320. Devices and/or elements of the environment 300 may interconnect via wired connections and/or wireless connections.

The user device 105 may include one or more devices capable of receiving, generating, storing, processing, and/or providing information, as described elsewhere herein.

The user device 105 may include a communication device and/or a computing device. For example, the user device 105 may include a wireless communication device, a mobile phone, a smartphone, a noise meter, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), a television, or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

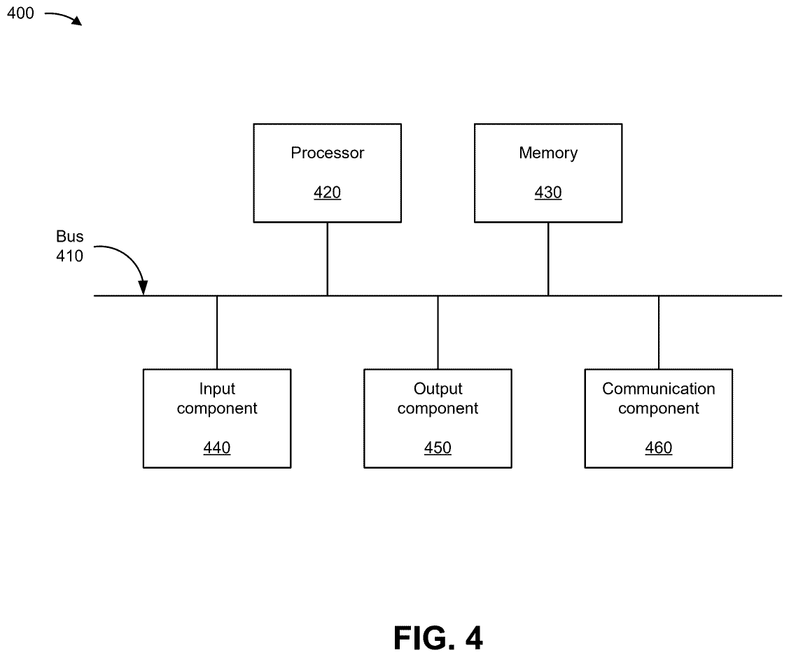

Although the image system 110 may include one or more elements 303-313 of the cloud computing system 302, may execute within the cloud computing system 302, and/or may be hosted within the cloud computing system 302, in some implementations, the image system 110 may not be cloud-based (e.g., may be implemented outside of a cloud computing system) or may be partially cloud-based. For example, the image system 110 may include one or more devices that are not part of the cloud computing system 302, such as a device 400 of FIG. 4, which may include a standalone server or another type of computing device. The image system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105 and/or the image system 110. In some implementations, the user device 105 and/or the image system 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

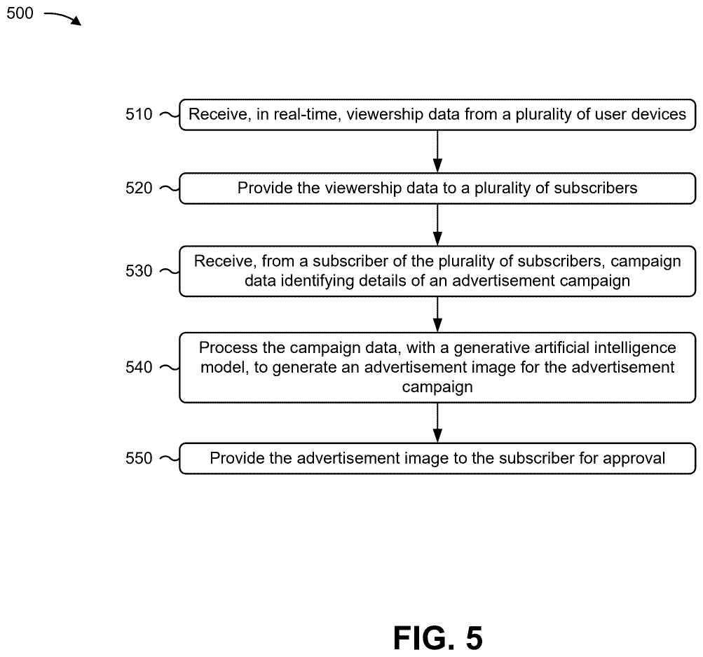

FIG. 5 depicts a flowchart of an example process 500 for utilizing a real-time generative AI model to generate an image based on campaign data. In some implementations, one or more process blocks of FIG. 5 may be performed by a device (e.g., the image system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving, in real-time, viewership data from a plurality of user devices (block 510). For example, the device may receive, in real-time, viewership data from a plurality of user devices, as described above. In some implementations, each of the plurality of user devices includes one of a set-top box, a desktop computer, a laptop computer, a tablet computer, a television, a wearable communication device, or a smartphone.

As further shown in FIG. 5, process 500 may include providing the viewership data to a plurality of subscribers (block 520). For example, the device may provide the viewership data to a plurality of subscribers, as described above. In some implementations, providing the viewership data to the plurality of subscribers includes providing the viewership data to the plurality of subscribers based on predefined criteria that include one or more of a channel selection, a state selection, a viewership threshold, or a genre selection.

As further shown in FIG. 5, process 500 may include receiving, from a subscriber of the plurality of subscribers, campaign data identifying details of an advertisement campaign (block 530). For example, the device may receive, from a subscriber of the plurality of subscribers, campaign data identifying details of an advertisement campaign, as described above. In some implementations, the details of the advertisement campaign include one or more of a landing page network address, a coupon code, a start time, an end time, or a template.

As further shown in FIG. 5, process 500 may include processing the campaign data, with a generative AI model, to generate an advertisement image for the advertisement campaign (block 540). For example, the device may process the campaign data, with a generative AI model, to generate an advertisement image for the advertisement campaign, as described above. In some implementations, the generative AI model is a GAN model.

As further shown in FIG. 5, process 500 may include providing the advertisement image to the subscriber for approval (block 550). For example, the device may provide the advertisement image to the subscriber for approval, as described above.

In some implementations, process 500 includes receiving, from the subscriber, an approval of the advertisement image or one or more changes to the advertisement image. In some implementations, process 500 includes implementing the one or more changes to generate a modified advertisement image based on receiving the one or more changes, and providing the modified advertisement image to the subscriber for approval. In some implementations, process 500 includes scheduling provision of the advertisement image at a scheduled time based on receiving the approval of the advertisement image, providing the advertisement image and a code to the plurality of user devices at the scheduled time and via one or more channels, receiving a selection of the code from one of the plurality of user devices, and providing a landing page for the advertisement campaign to the one of the plurality of user devices based on the selection of the code.

In some implementations, process 500 includes scheduling provision of the advertisement image at a scheduled time based on receiving an approval of the advertisement image from the subscriber, and providing the advertisement image and a code to the plurality of user devices at the scheduled time and via one or more channels. In some implementations, the one or more channels include one or more of a television guide launch page, a mobile notification provided to the plurality of user devices, or a web page. In some implementations, the code is a QR code that links to a landing page for the advertisement campaign.

In some implementations, process 500 includes automatically creating an advertisement campaign in a campaign management system based on the advertisement image and the details of the advertisement campaign. In some implementations, process 500 includes receiving, from the subscriber, a prebooked time slot for the advertisement campaign based on the viewership data satisfying a threshold.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, in real-time by a device, viewership data from a plurality of user devices;
providing, by the device, the viewership data to a plurality of subscribers;
receiving, by the device and from a subscriber of the plurality of subscribers, campaign data identifying details of an advertisement campaign;
processing, by the device, the campaign data, with a generative artificial intelligence model, to generate an advertisement image for the advertisement campaign; and
providing, by the device, the advertisement image to the subscriber for approval.

2. The method of claim 1, further comprising:
receiving, from the subscriber, an approval of the advertisement image or one or more changes to the advertisement image.

3. The method of claim 2, further comprising:
implementing the one or more changes to generate a modified advertisement image based on receiving the one or more changes; and
providing the modified advertisement image to the subscriber for approval.

4. The method of claim 2, further comprising:
scheduling provision of the advertisement image at a scheduled time based on receiving the approval of the advertisement image;
providing the advertisement image and a code to the plurality of user devices at the scheduled time and via one or more channels;
receiving a selection of the code from one of the plurality of user devices; and
providing a landing page for the advertisement campaign to the one of the plurality of user devices based on the selection of the code.

5. The method of claim 1, wherein the generative artificial intelligence model is a generative adversarial network model.

6. The method of claim 1, wherein each of the plurality of user devices includes one of a set-top box, a desktop computer, a laptop computer, a tablet computer, a television, a wearable communication device, or a smartphone.

7. The method of claim 1, wherein providing the viewership data to the plurality of subscribers comprises:
providing the viewership data to the plurality of subscribers based on predefined criteria that include one or more of a channel selection, a state selection, a viewership threshold, or a genre selection.

8. A device, comprising:
one or more processors configured to:
receive, in real-time by a device, viewership data from a plurality of user devices;
provide the viewership data to a plurality of subscribers based on predefined criteria that include one or more of a channel selection, a state selection, a viewership threshold, or a genre selection;
receive, from a subscriber of the plurality of subscribers, campaign data identifying details of an advertisement campaign;
process the campaign data, with a generative artificial intelligence model, to generate an advertisement image for the advertisement campaign; and
provide the advertisement image to the subscriber for approval.

9. The device of claim 8, wherein the details of the advertisement campaign include one or more of a landing page network address, a coupon code, a start time, an end time, or a template.

10. The device of claim 8, wherein the one or more processors are further configured to:
schedule provision of the advertisement image at a scheduled time based on receiving an approval of the advertisement image from the subscriber; and
provide the advertisement image and a code to the plurality of user devices at the scheduled time and via one or more channels.

11. The device of claim 10, wherein the one or more channels include one or more of a television guide launch page, a mobile notification provided to the plurality of user devices, or a web page.

12. The device of claim 10, wherein the code is a quick response code that links to a landing page for the advertisement campaign.

13. The device of claim 8, wherein the one or more processors are further configured to:
automatically create an advertisement campaign in a campaign management system based on the advertisement image and the details of the advertisement campaign.

14. The device of claim 8, wherein the one or more processors are further configured to:
receive, from the subscriber, a prebooked time slot for the advertisement campaign based on the viewership data satisfying a threshold.

15. A non-transitory computer-readable medium storing a set of instructions, the set of instructions comprising:
one or more instructions that, when executed by one or more processors of a device, cause the device to:
receive, in real-time by a device, viewership data from a plurality of user devices;
provide the viewership data to a plurality of subscribers;
receive, from a subscriber of the plurality of subscribers, campaign data identifying details of an advertisement campaign,
wherein the details of the advertisement campaign include one or more of a landing page network address, a coupon code, a start time, an end time, or a template;
process the campaign data, with a generative artificial intelligence model, to generate an advertisement image for the advertisement campaign; and
provide the advertisement image to the subscriber for approval.

16. The non-transitory computer-readable medium of claim 15, wherein the one or more instructions further cause the device to:
receive, from the subscriber, an approval of the advertisement image or one or more changes to the advertisement image.

17. The non-transitory computer-readable medium of claim 16, wherein the one or more instructions further cause the device to:
implement the one or more changes to generate a modified advertisement image based on receiving the one or more changes; and
provide the modified advertisement image to the subscriber for approval.

18. The non-transitory computer-readable medium of claim 16, wherein the one or more instructions further cause the device to:
schedule provision of the advertisement image at a scheduled time based on receiving the approval of the advertisement image;
provide the advertisement image and a code to the plurality of user devices at the scheduled time and via one or more channels;
receive a selection of the code from one of the plurality of user devices; and
provide a landing page for the advertisement campaign to the one of the plurality of user devices based on the selection of the code.

19. The non-transitory computer-readable medium of claim 15, wherein the one or more instructions further cause the device to:
automatically create an advertisement campaign in a campaign management system based on the advertisement image and the details of the advertisement campaign.

20. The non-transitory computer-readable medium of claim 15, wherein the one or more instructions further cause the device to:
receive, from the subscriber, a prebooked time slot for the advertisement campaign based on the viewership data satisfying a threshold.
